(19) United States
(12) Patent Application Publication
(10) Pub. No.: US 2005/0074596 A1
(43) Pub. Date: Apr. 7, 2005

(54) Method and system for using porous structures in solid freeform fabrication

(76) Inventors: Jeffrey A. Nielsen, Corvallis, OR (US); Tony S. Cruz-Uribe, Corvallis, OR (US); David C. Collins, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/680,366

(22) Filed: Oct. 6, 2003

(51) Int. Cl. B29C 35/08

(52) U.S. Cl. 428/304.4; 264/497; 264/113; 700/98; 425/375

(57) ABSTRACT

A method for producing porous structures in a three-dimensional object with solid freeform fabrication includes selectively depositing a removable support material, depositing a build material defining the three-dimensional object, and removing the selectively deposited removable support material to form a number of pores within the three-dimensional object.

### BACKGROUND

Solid freeform fabrication (SFF) is a process for manufacturing three-dimensional objects. Typical objects that may be manufactured using SFF include, for example, prototype parts, production parts, models, and working tools. SFF is an additive process in which a desired object is described by electronic data and automatically built from base materials. There are two main types of liquid-ejection SFF techniques that selectively jet liquid material to directly fabricate objects: binder/powder based SFF and bulk liquid jetting based SFF.

Binder/powder based SFF is a method wherein a cement forming powder is spread in bulk and then selectively receives a liquid binder. The liquid binder and the cement forming powder then combine to form a hardenable cement that may be hardened to form the desired three-dimensional object. Alternatively, binder/powder based SFF may bind particles together. For example, “glue” could be used to bind spherical particles of stainless steel without any reaction between the particles and the “glue.” Binder/powder based SFF generally creates a three-dimensional object made of a porous material that can later be infiltrated with other material. However, the porosity of the resulting material is very difficult to control and often results in a poor surface finish.

The second type of liquid-ejection SFF, bulk liquid jetting based SFF, generally includes the selective deposition of two different solidifiable materials, one material being used to fabricate the desired three-dimensional object and the other material being a sacrificial material used to build a support structure for the build material. The two solidifiable materials may be deposited by a dispensing mechanism as individual drops of material known as voxels. Once the individual voxels of material are deposited, they solidify to form the desired three-dimensional object. Liquid-ejection SFF offers generally improved surface finish when compared to the binder/powder based SFF method mentioned above. However, liquid-ejection SFF does not inherently create a porous structure that allows for infiltrating with additional material.

### SUMMARY

A method for producing porous structures in a three-dimensional object with solid freeform fabrication includes selectively depositing a removable support material, depositing a build material defining the three-dimensional object, and removing the selectively deposited removable support material to form a number of pores within the three-dimensional object.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a perspective view of an SFF system that may be used to implement exemplary embodiments of the present system and method.

FIG. 2 is a schematic view illustrating the components of an SFF system according to one exemplary embodiment.

FIG. 3 is a schematic view illustrating the components of an SFF system according to an additional exemplary embodiment.

FIG. 4 is a flow chart illustrating a method for creating controlled porosity in fully dense selective deposition SFF according to one exemplary embodiment.

FIGS. 5A through 5D illustrate the present system and method for creating controlled porosity in fully dense selective deposition SFF according to exemplary embodiments.

FIGS. 6A and 6B illustrate a method for creating controlled porosity in an SFF article using a rapidly solidifiable build material according to one exemplary embodiment.

FIG. 7 is a flow chart illustrating a method for creating controlled porosity in an SFF article using a rapidly solidifiable support material according to one exemplary embodiment.

FIGS. 8A through 8C illustrate a method for creating controlled porosity in an SFF article using rapidly solidifiable support material according to one exemplary embodiment.

Throughout the drawings, identical reference numbers designate similar, but not necessarily identical, elements.

### DETAILED DESCRIPTION

A method and apparatus for creating objects having a porous structure with a solid freeform fabrication (SFF) system is described herein. More specifically, a method is described for using bulk liquid jetting based SFF to selectively create pores in an SFF structure that may subsequently be infiltrated with property enhancing material.

As used in this specification and in the appended claims, the term “high precision dispenser” is meant to be understood broadly as any dispensing equipment configured to perform a high precision process. Alternatively, the term “low precision dispenser” refers to dispensing equipment that is configured to eject material according to a low precision process and may, under some circumstances, eject a continuous flow. Moreover, a single material dispenser may be configured to selectively operate as both a high precision dispenser and a low precision dispenser. “Flow” or “continuous flow” is meant to be understood broadly to include a fluid stream that is not defined by individual drops or bubbles but is not necessarily completely uninterrupted. The term “voxel” describes a volumetric pixel of an addressable volume having length in x, y, and z coordinates. The term “cure” refers to a process of solidification that may also impart a degree of chemical resistance to an object being cured. The term “solidify” is meant to be understood as any process for adding a degree of support strength or hardness to a material while not necessarily permanently setting the state of the material. Additionally, the term “substrate” is meant to be understood as any build platform, removable material, or previously deposited build material. A “build platform” is typically a rigid substrate that is used to support deposited material from a SFF apparatus.

In the following description, for purposes of explanation, numerous specific details are set forth in order to provide a thorough understanding of the present SFF system and method. It will be apparent, however, to one skilled in the art that the present system and method may be practiced without these specific details. Reference in the specification to “one embodiment” or “an embodiment” means that a particular feature, structure, or characteristic described in connection with the embodiment is included in at least one embodiment. Appearances of the phrase “in one embodiment” in various places in the specification do not necessarily all refer to the same embodiment.

Exemplary Structure

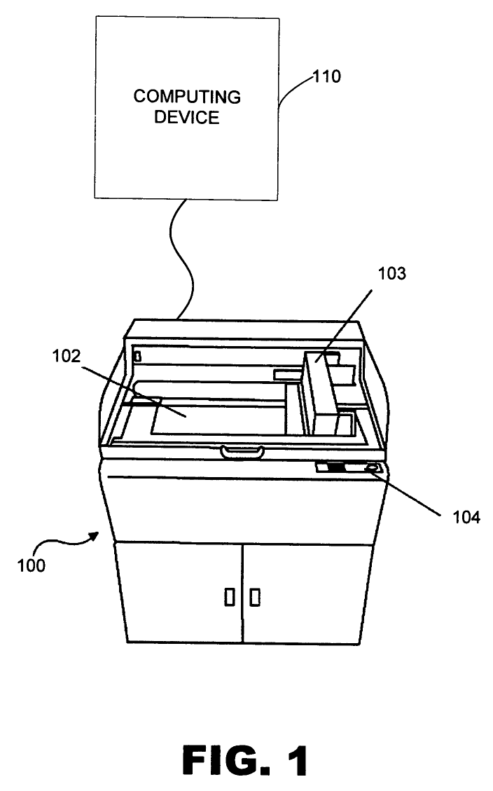

Referring now to FIG. 1, an SFF system (100) that may incorporate the present SFF method is illustrated. As shown in FIG. 1, an SFF system may include a fabrication bin (102), a moveable stage (103), and a display panel (104) including a number of controls and displays. Moreover, as shown in FIG. 1, the SFF system may also be communicatively coupled to a computing device (110).

The fabrication bin (102) of the SFF system (100) shown in FIG. 1 is configured to receive object build material and facilitate the building of a desired three-dimensional object on a substrate. The fabrication bin (102) may also receive support material configured to receive and support the above-mentioned build material. The support material may be deposited within the fabrication bin (102) either prior to or simultaneously with the deposition of the object build material. While the SFF system (100) illustrated in FIG. 1 is shown as a single, stand-alone, self-contained SFF system, the present SFF methods may be incorporated into any SFF system regardless of structure or configuration.

The moveable stage (103) illustrated in FIG. 1 is a moveable material dispenser that may include individual dispensers configured to operate as high precision and/or low precision dispensers. The dispensers (not shown) of the moveable stage may include, but are in no way limited to, one or more inkjet material dispensers. The inkjet material dispensers used by the SFF system (100) may be any type of inkjet dispenser configured to perform the present method including, but in no way limited to, thermally actuated inkjet dispensers, mechanically actuated inkjet dispensers, electrostatically actuated inkjet dispensers, magnetically actuated inkjet dispensers, piezoelectrically actuated inkjet dispensers, continuous inkjet dispensers, etc. Additionally, the ink-jet dispenser can be heated to assist in dispensing viscous chemical compositions. The moveable stage (103) may be controlled by a computing device (110) and may be controllably moved by, for example, a shaft system, a belt system, a chain system, etc. As the moveable stage (103) operates, the display panel (104) may inform a user of operating conditions as well as provide the user with a user interface.

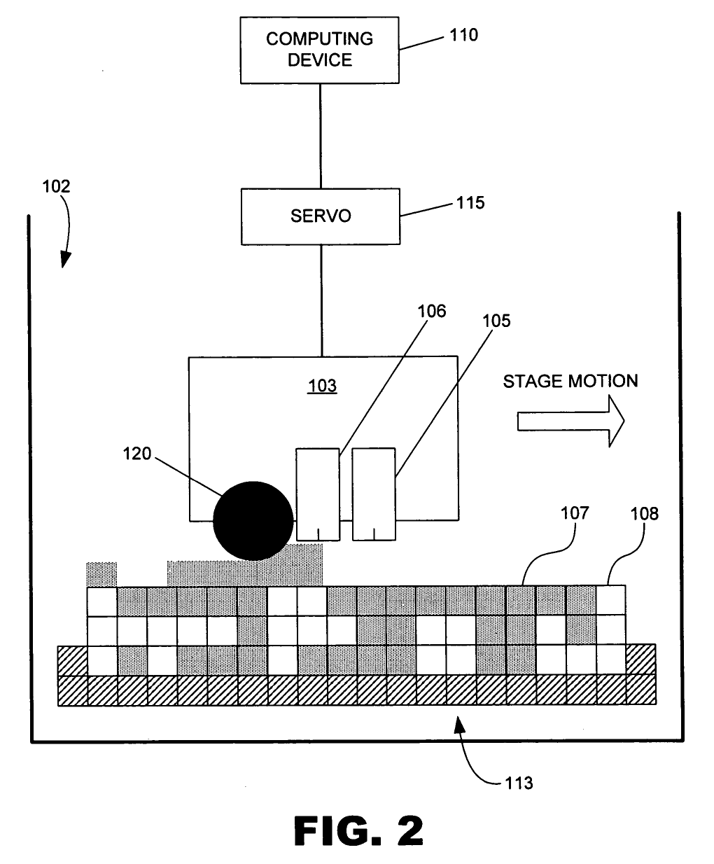

FIG. 2 illustrates the association between the components of the SFF system and a desired three-dimensional object. As shown in FIG. 2, the SFF system may include a computing device (110), servo mechanisms (115), a substrate (113), and a moveable stage (103) including, among other components, a roller (120) and a number of material dispensers (105, 106) such as a print head capable of selectively operating either as a high precision dispenser or as a low precision dispenser. As shown in FIG. 2, the computing device (110) may be communicatively coupled to the servo mechanisms (115), which are then coupled to the moveable stage (103). The computing device (110) may be any device configured to translate coordinates representing a modeled segment of a desired three-dimensional object or its necessary support material into suitable servo commands for the servo mechanisms (115). The servo mechanisms (115) may then respond to the commands issued by the computing device (110) and position the moveable stage such that it may deposit build and/or support material to designated locations. The components of the moveable stage (103) are positioned such that they may deposit build and/or support material on a substrate (113) or build platform located inside the fabrication bin (102) at x, y, and z coordinates designated by the computing device (110). Additionally, the fabrication bin (102) may be moveable in order to facilitate the deposition of build and/or support material.

The material dispensers (105, 106) illustrated in FIG. 2 may be a single print head containing multiple orifices (at least one orifice for dispensing build material (107), and another for dispensing support material (108)) or multiple material dispensers of the same or different types (at least one dispenser for dispensing build material, and another for dispensing support material). The material dispensers (105, 106) may be configured to function according to high or low precision dispensing methods upon demand by the computing device (110). The term “high precision dispensing” is meant to be understood both here and in the appended claims as a method whereby a material dispenser (105, 106) selectively deposits support and/or build material using high precision dispensing methods including, but in no way limited to, allowing a minimal distance between the material dispensers (105, 106) and a target area, incorporating a low material drop rate and frequency, implementing a low carriage speed, receiving a high resolution data set, or any appropriate combination thereof. As is noted above, the material dispensers (105, 106) may also dispense support material or build material according to typically faster, low precision methods. The level of precision exhibited by the material dispensers (105, 106) may depend on a number of factors including, but in no way limited to, distance between the material dispensers (105, 106) and a target area, material drop rate used by the material dispensers (105, 106), frequency, firing method incorporated, quality of feedback mechanism, carriage speed, resolution of data set, etc.

The roller (120) illustrated in FIG. 2 may be configured to level or planarize material after the material has been dispensed. Planarization is meant to be understood broadly both here and in the appended claims to mean any operation that may be performed on a deposited material that removes excess material, consolidates deposited material, and/or improves the surface finish of the material. According to the present method, the planarization may occur following the dispensing of a single quantity of material and/or following the dispensing of multiple quantities of material. The roller (120) may follow the print head (105, 106) to planarize dispensed object build material (107) or support material (108) and create a generally uniform thickness and surface finish in the material. The planarization may be performed by a roller (120) as shown in FIG. 2, by a device that contains a doctor blade (not shown), or any other device configured to remove excess material from a dispensed material.

The support material (108) illustrated in FIG. 2 is made up of a series of voxels that may support build material and/or form a cavity within the desired three dimensional object. The support material (108) voxels may be stacked in vertical stacks of multiple voxels, or linearly placed in a planar array. The support material (108) may be composed of any material capable of being ejected from an inkjet material dispenser operating as a high precision dispenser while providing surface definition to object build material including, but in no way limited to polymers, wax, or other similar meltable or otherwise sacrificial materials or appropriate combinations thereof.

The desired three-dimensional object that is formed on the substrate (113) may be built from an object build material (107) as shown in FIG. 2. The object build material (107) may be any solidifiable material capable of assuming the shape of a desired three-dimensional object after being dispensed by one or more of the material dispensers (105) including, but in no way limited to, a polymer or a wax. To build each segment of the desired three-dimensional object, a quantity of the object build material (107) may be provided from one of the material dispensers (105) as voxels that may be either vertically stacked, linearly placed by a dispenser operating as a high precision dispenser, or supplied in mass by a dispenser operating as a low precision dispenser. The material dispenser (105) operating as a low precision dispenser may include an inkjet print head, a piezoelectric print head, a thermal inkjet print head, a continuous jet print head, a valve jet print head, a syringe mechanism, or any other dispenser capable of dispensing a specified quantity of build material (107) upon request from the computing device (110).

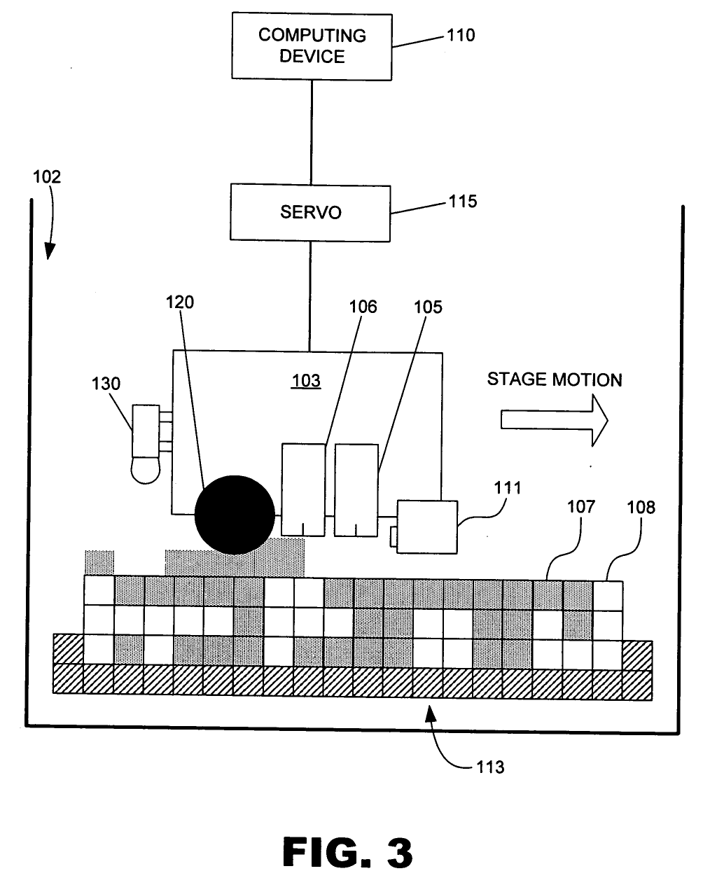

FIG. 3 illustrates an additional exemplary configuration that may be used to incorporate the present SFF methods. The structure illustrated in FIG. 3 shows a computing device (110), servo mechanisms (115), a substrate (113), and a moveable stage (103) including material dispensers (105) and a roller (120) similar to the structure illustrated in FIG. 2. However, FIG. 3 also includes a feedback device (111) configured to monitor and control the dispensing of the object build (107) and support (108) material and a radiation applicator (130) configured to apply radiation to the dispensed material after the deposition of each segment. The feedback device (111) may include, but is in no way limited to, an optical sensor, a flow meter, or any other device that may be used to monitor and control the volume of object build material (107) dispensed by the material dispenser (105) operating as either a high precision or a low precision dispenser. Additionally, the radiation applicator (130) may be any device configured to apply ultraviolet (UV) or other radiation sufficient to solidify or cure deposited material. As shown in FIG. 3, the radiation applicator (130) may be coupled to the moveable stage (103) as a scanning unit. Alternatively, the radiation applicator (130) may be a separate light exposer or scanning unit configured to flood expose all or selective portions of deposited material after a segment of build material has been deposited.

Returning again to FIG. 2, the movable stage (103) of the SFF system (100; FIG. 1) may include inkjet technology, such as continuous or drop-on-demand liquid ejection devices including thermal and/or piezoelectric inkjets, for depositing the support material (108) and/or object build material (107). Additionally, the moving stage may include additional components configured to form or color the desired three-dimensional object. If the moving stage (103) incorporates continuous or drop-on-demand inkjet technology, the moving stage may include one or more material dispensers (105) such as print heads configured to eject materials, clear or colored, in a selective pattern to add color or texture to the object or the support structure being fabricated.

As discussed above, the material dispensers (105, 106) may be configured to selectively function as a high precision printhead when required by the computing device (110). However, rather than requiring the material dispensers (105, 106) to continually function as a temporally expensive, high precision dispenser, the material dispensers (105, 106) may also selectively operate as a low precision dispenser when directed by the computing device (110). When operating as a low precision dispenser, the material dispensers (105, 106) may eject bulk amounts of material. Accordingly, the three-dimensional objects built according to the principles described herein may be built more quickly and cheaply than previous SFF systems that require material ejection by high precision methods at each voxel of a desired three-dimensional object while providing the flexibility of producing porous structures in the SFF.

Exemplary Implementation and Operation

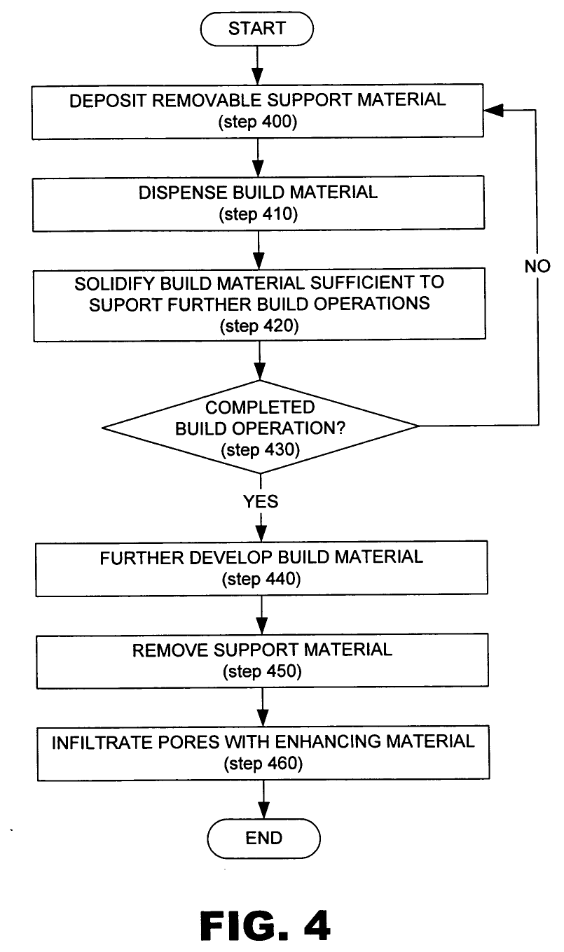

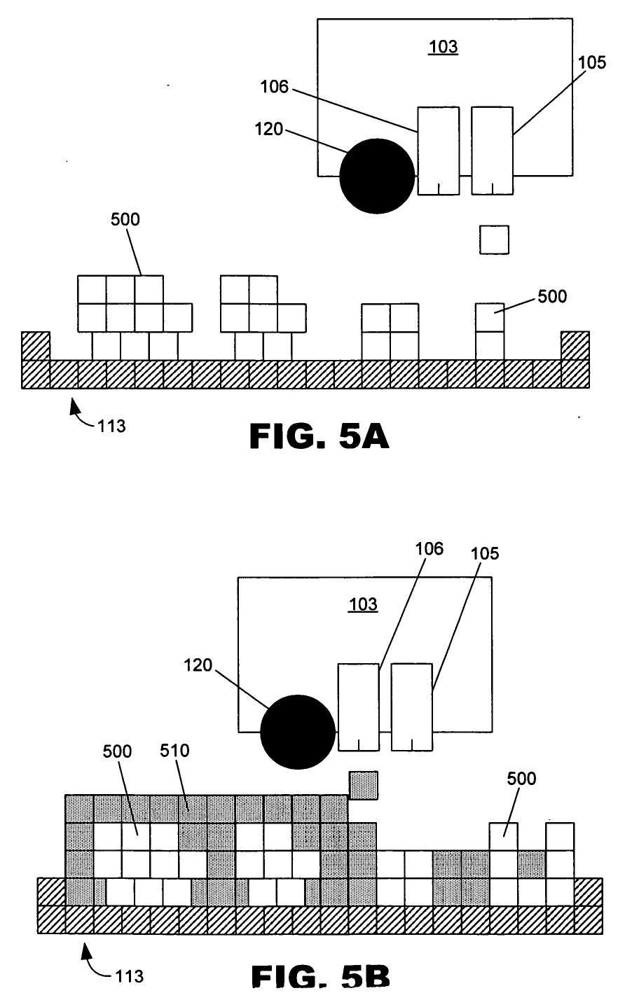

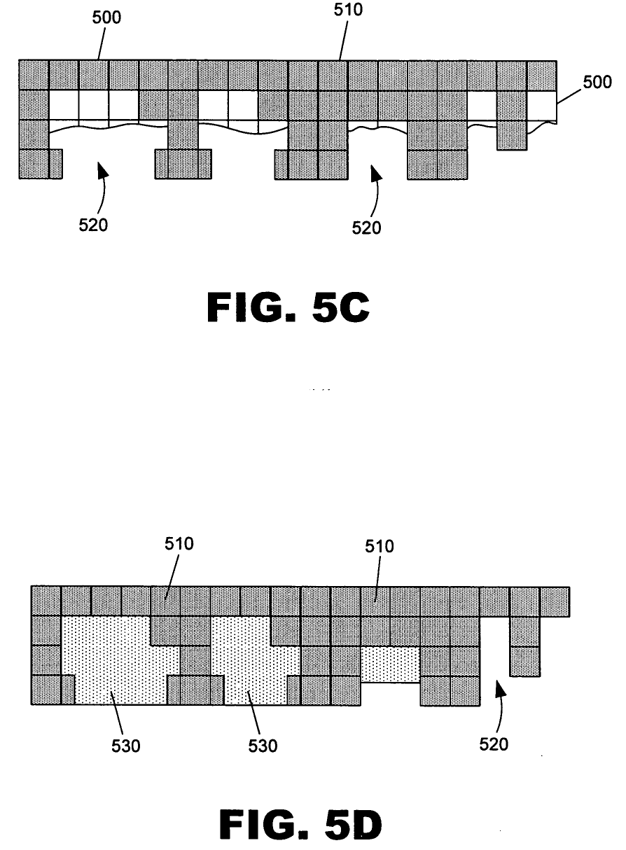

FIG. 4 illustrates a method for creating controlled porosity in fully dense selective deposition SFF according to one exemplary embodiment. As shown in FIG. 4, the exemplary embodiment begins by dispensing removable support material onto the substrate (step 400) followed by the dispensing of object build material onto the substrate (step 410). Once both the removable support material and the build material have been dispensed, the build material is solidified sufficiently to support further build operations (step 420). During or after the build material has been sufficiently solidified to support further build materials, the computing device (110; FIG. 2) determines whether the SFF apparatus has completed the build operation (step 430). If the build operation is not complete (NO, step 430), then the SFF apparatus again dispenses removable support material (step 400) and begins the build process again. If, however, the computing device (110; FIG. 2) determines that it has completed the build operation (YES, step 430), then the SFF apparatus further develops the build material (step 440) and removes the sacrificial support material (step 450). Once the sacrificial support material is removed from the desired three-dimensional object, the user may infiltrate the remaining pores with property enhancing materials (step 460). The above-mentioned method will now be explained in further detail below with reference to FIGS. 5A through 5D.

As shown in FIG. 4, one exemplary method for creating controlled porosity in fully dense selective deposition SFF begins with the SFF apparatus (100; FIG. 1) dispensing removable support material (step 400). FIG. 5A illustrates removable support material (500) being dispensed onto a substrate (113) by an SFF apparatus according to one exemplary embodiment. The removable support material (500) may be dispensed directly onto the substrate (113) as illustrated in FIG. 5A, or it may be dispensed on previously dispensed material. The removable support material (500) defines the volume of the possible pores that exist in the resulting three-dimensional object and therefore may be formed by a material dispenser (105, 106) functioning as a high precision dispenser. When dispensed, the removable support material voxels (500) may vary in size when compared to the build material voxels. Additionally, the removable support material voxels (500) may be selectively stacked in a vertical fashion as illustrated in FIG. 5A, or they may be linearly placed in a planar array. According to an alternative embodiment, the material used for forming pores could be of a third material which is highly soluble for easy extraction because it is not required to have the mechanical strength that a support material has. It may in fact be soft or gel-like. Once the removable support material (500) is deposited, the SFF apparatus may optionally planarize the deposited material with a roller (120) or other similar device. The optional planarization may either occur layer by layer or it may occur on a number of stacked voxels.

Once the specified quantity of removable support material (500) has been dispensed according to one exemplary embodiment, or simultaneous with the deposition of the support material in another embodiment, the SFF apparatus (100; FIG. 1) may selectively dispense build material (step 410; FIG. 4). FIG. 5B illustrates an SFF apparatus (100; FIG. 1) dispensing build material (510) around removable support material (500) voxels. The build material (510) may be dispensed by the material dispensers (105, 106) either in bulk or by selective deposition of voxels. If the build material employed in the present system is readily flowable, the build material may be dispensed in bulk and allowed to flow around and occupy area not occupied by the removable support material (500). If, however, the build material (510) is quickly solidifiable, the material will be dispensed by a material dispenser (105, 106) functioning as a high precision dispenser. Similar to the removable support material, the build material (510) may optionally be planarized after one or more voxels of build material have been dispensed.

Once both the removable support material (510) and the build material (510) have been dispensed onto the substrate (113) or onto previously dispensed material, the SFF apparatus may sufficiently solidify the build material to support further build operations (step 420; FIG. 4). The build material (510) may be partially solidified either by electromagnetic radiation, the application of heat, or a chemical cure activated by chemical agents present in the build material (510) when deposited. The build material may be solidified through partial curing, such that the partially cured segments of build material will support subsequently deposited build or support material. By partially curing the deposited material rather than completely curing each segment upon deposition, intermediate solidification time is reduced along with overall process time.

Either simultaneous with or after the SFF apparatus (100; FIG. 1) has somewhat solidified the build material (510), the computing device (110; FIG. 1) determines whether or not the SFF apparatus has completed the build operation (step 430; FIG. 4). If the computing device (110; FIG. 1) determines that the building of the desired three-dimensional object is not complete and additional quantities of build and/or support material should be deposited to complete the desired three-dimensional object (NO, step 430; FIG. 4), then the computing device may cause the SFF system (100; FIG. 1) to again dispense removable support material (step 400; FIG. 4) and continue the building process. If, however, the computing device (100; FIG. 1) determines that the building of the three-dimensional object is complete (YES, step 440) based on the modeled version of the three-dimensional object, the SFF system (100; FIG. 1) may further develop the build material (step 440).

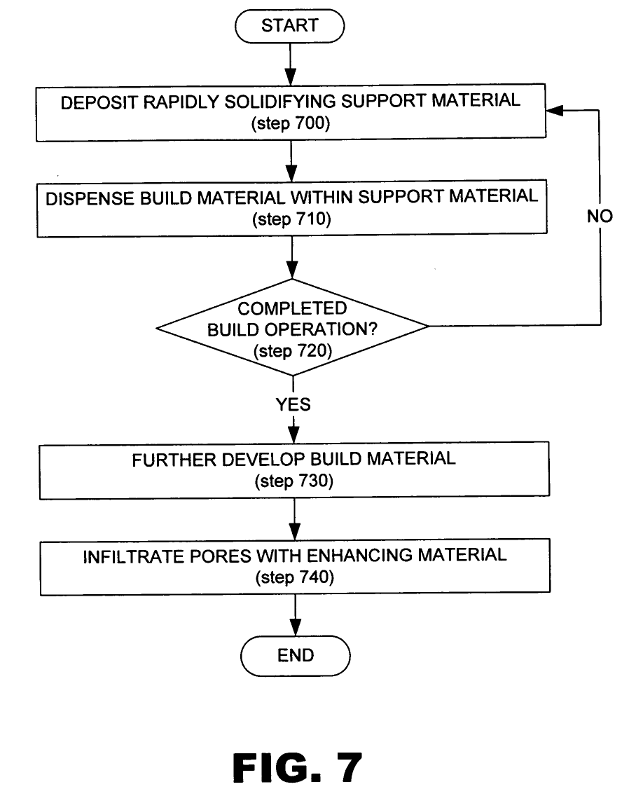

Once the build operation is completed (YES, step 430; FIG. 4), the SFF apparatus may further develop the build material (step 440; FIG. 4) to form the desired three-dimensional object. Further developing of the build material (107; FIG. 7B) may be required upon completion of the material dispensing operation because, as explained above, the build material may only be solidified sufficiently during the build process to support subsequent quantities of build material. The further development of the build material (step 450) may occur by any number of curing means including, but in no way limited to, the application of electromagnetic radiation, UV radiation, heat, or a chemical cure activated by chemical agents present in the build material when deposited.

Once the build material has been further developed, the removable support material (500) may be removed from within the desired three-dimensional object (step 450; FIG. 4). FIG. 5C illustrates the removal of removable support material (500) from within the deposited build material (510) to produce a number of selectively formed pores (520). Some parts of the removable support material are interconnected, fine, and accessible to the exterior in areas that allow it to be removed. The capillary-like pore structure remaining once the removable support material (500) is removed imparts properties to the structure or allows for infiltrants, which may fill or coat the interior surfaces. The capillary-like pore structures remaining in the deposited build material (510) may have varying cross-sections to allow for wicking of materials in different directions and with varying densities. The removable support material (500) may be separated from the deposited build material (510) in a number of ways including, but in no way limited to, melting the removable support material, dissolving the removable support material, physically or manually extracting the removable support material, etc. These processes will be further explained below.

One exemplary method for melting a removable support material (500) from a desirable three-dimensional object is to immerse the composite structure in a solution that has been heated to a temperature above the melting point of the support material (500), but below that of the build material (510). Once immersed, the heat from the solution may cause the support material (500) to melt from the build material (510) of the desired three-dimensional object. As shown in FIG. 5C, as the removable support material is melted away from the build material (510), a number of selectively formed pores (520) are formed that may subsequently be filled or coated with any number of infiltrants.

In an alternative embodiment, the build material and the containment material may be chosen to exhibit opposite vulnerabilities to the action of a solvent. For example, the containment material might be a polar material with the build material being a non-polar material. In this exemplary embodiment, the final composite structure may be immersed in a polar solvent that causes the polar containment material to dissolve away leaving only the build material (510), containing selectively formed pores (520) therein.

In another exemplary embodiment, the build material may be curable upon exposure to radiation of a predetermined wavelength, while the containment material is not. After each quantity of build material is deposited, it may be exposed to radiation prior to the deposition of subsequent build material. So long as the cured material exhibits some interaction with identical material in the uncured state, the final composite structure will have differing hardness characteristics. Separation of the two components may then be accomplished by suitable physical or chemical means.

In yet another embodiment, the two materials may be chosen for their immiscibility with respect to one another. So long as the finished three-dimensional object does not contain topologically opposed components, it may be separated manually from the surrounding support material due to a lack of adhesion leaving only selectively formed pores (520).

Once the build material has been removed (step 450), capillary-like pores (520) exist in the remaining build material (510). These pores (520) may then be infiltrated with property enhancing materials (step 460; FIG. 4) as shown in FIG. 5D. Pore structures with at least two openings more readily allow infiltration since one end can allow air to escape. Property enhancing materials (530) that may be infiltrated in the pores (520) include, but are in no way limited to, a high toughness material to improve the wear characteristics of a material; a highly flexible agent to strengthen and make more elastic a member such as a latch or a protrusion; a lubricant, odorant, de-odorant, or drug could be entrained and slowly released; a colorant could coat the surface or fill the pores to enhance the outward appearance of the three-dimensional object, the inner surfaces could be reacted with a gas or liquid to change color, electrical properties, chemical reactivity, etc.; and/or adhesive may be infiltrated in the pore (520) using the pores to enhance adhesion between parts due to an increased surface area. Property enhancing materials (530) that may be infiltrated in the pores (520) might also include materials that modify the electrostatic and electromagnetic properties of the resulting three-dimensional object by being conductive. The increase in conductivity could be used to dissipate charge or act as a shield. Examples of materials that could modify the electrostatic and electromagnetic properties of the resulting three-dimensional object include, but are in no way limited to, a colloidal solution of carbon particles and a binder or a two part electrolysis process to deposit a metal by first adding solution with metal ion and then adding a second solution with reducing or catalyzing agent.

FIG. 5D also illustrates that the pores (520) may remain open or filled with air or another gas according to one exemplary embodiment. Parts of the support network that are embedded within the part and are not portions of support material can be used to encapsulate air pockets within the part that have several advantages including, but in no way limited to, stress relief, transparency modulation, etc. Moreover, the pores could be designed to change the appearance of the object with translucence, opalescence, or other optical scattering effects. Additionally, open pores could act as air vents, passageways, or fluidic micro-ducts for a number of applications.

The present system and method allow for the creation of areas of controlled porosity whereas traditional techniques that create porous materials are of uncontrolled porosity. With this controlled porosity, multiple materials may be formed within a selectively jetted part by creating infiltration structures in areas of interest.

Additionally, the controlled porosity may allow for the reduction of part distortion and bowing that often result from the buildup of stresses. By including air pockets within the interior of the desired three-dimensional object, internal stresses caused by expansion of a material may be relieved as the material compresses the air pockets. In effect, the air pockets are acting much like an expansion joint used in other fields. This use of air pockets as expansion joints prevents distortion or bowing of the part under stresses such as heat that is introduced into the desired three-dimensional part during fabrication, or stresses introduced due to fluid absorption.

The porosity created according to the present system and method may also allow for the variation of the overall density of part. The addition of pores traversing the build material allows for modulation of the bulk density of the part to better match the desired density in cases when the density of the material being used to fabricate the part is higher than the desired final part density.

Moreover, the present system and method for selectively creating areas of controlled porosity allow for variation in part transparency/opaqueness in cases when the material is more transparent than is desirable. Adding the interior air pockets to the desired three-dimensional object may increase light scattering and make a transparent material more opaque.

While the above-mentioned method has been explained in the context of two material dispensers capable of selectively operating as either high precision dispensers or as low precision dispensers, the present method may be implemented in a SFF device having any number of material dispensers wherein at least one dispenser is capable of operating as low precision dispenser and at least one dispenser is capable of operating as a high precision dispenser.

Alternative Embodiments

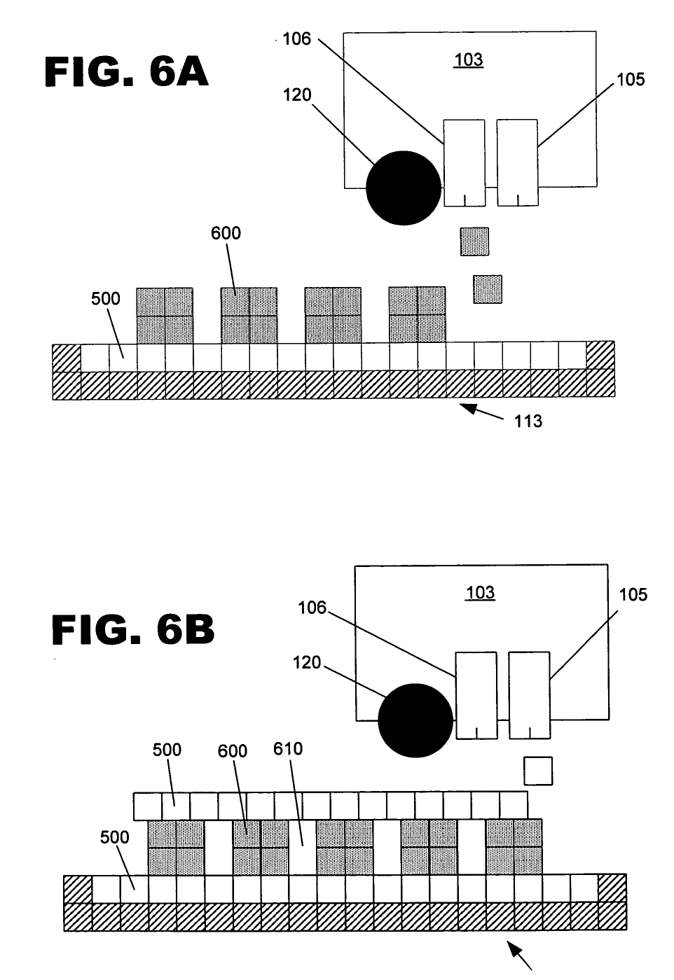

FIGS. 6A and 6B illustrate an alternative embodiment for forming areas of controlled porosity with an SFF apparatus. FIGS. 6A and 6B illustrate a method for forming areas of controlled porosity using a rapidly solidifiable build material (600). As shown in FIG. 6A, if the build material (600) is rapidly solidifiable, multiple voxels of build material (600) may be independently dispensed onto either a substrate (113) or onto previously deposited material. By spacing the deposition of the rapidly solidifiable build material (600), intentional pores (610) may be formed between the voxels. According to the alternative embodiment illustrated in FIG. 6A, the rapidly solidifiable build material (600) is deposited by a material dispenser (105, 106) functioning as a high precision dispenser because the pores (610) are formed directly by the placement of the build material (600).

FIG. 6B further illustrates how the formed pores (610) may be selectively sealed. As shown in FIG. 6B, voxels of either rapidly solidifiable build material (600) or support material (500) may be selectively deposited by a high precision dispenser (105, 106) to overhang pores (610) created between the rapidly solidifiable build material voxels (600). This allows for the pores (610) to be both directly formed and sealed within the desired three-dimensional object as it is being fabricated. The alternative embodiment illustrated in FIGS. 6A and 6B reduce the time needed to produce a selectively porous three-dimensional object because there is no need to deposit or remove support material (500) to create the selectively formed pores (610).

FIG. 7 illustrates yet another alternative embodiment to the present system and method for selectively forming pores in a three-dimensional object with an SFF apparatus. The embodiment illustrated in FIG. 7 provides a method for selectively forming pores using a support material that is rapidly solidifiable and a build material that is not. As shown in FIG. 7, the process begins by the SFF apparatus selectively depositing rapidly solidifying support material (step 700). Once the rapidly solidifying support material has been deposited, the SFF apparatus may dispense a bulk amount of build material within the boundaries of the support material (step 710). Once both the build and support material have been dispensed, the computing device determines if the build operation has been completed (step 720). If the build operation is not yet complete (NO, step 720), then the SFF apparatus again dispenses build and support material. If, however, the computing device determines that the build operation has been completed (YES, step 720), the SFF apparatus may further develop the build material (step 730) and infiltrate the created pores with property enhancing materials (step 740). The above mentioned process will now be described in further detail below.

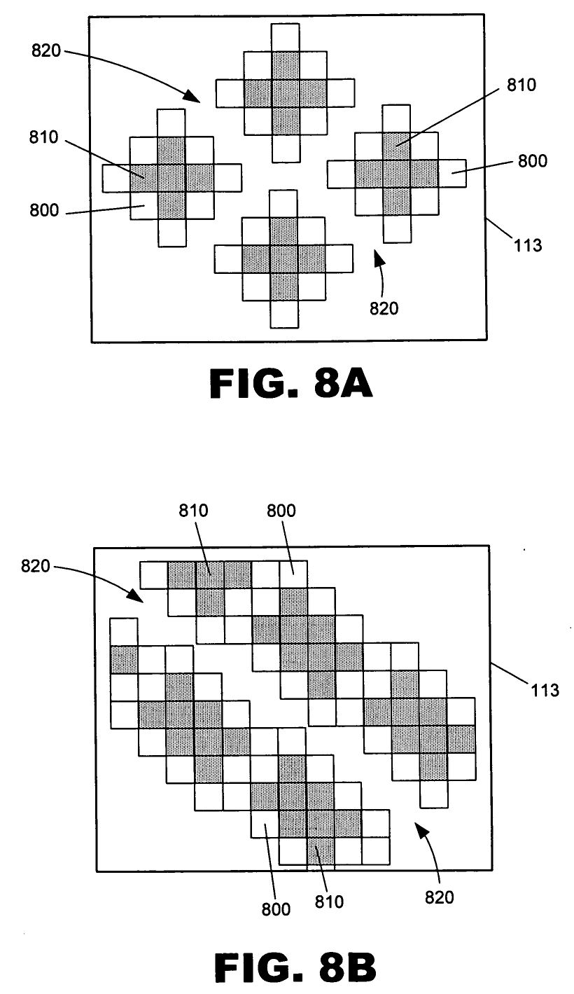

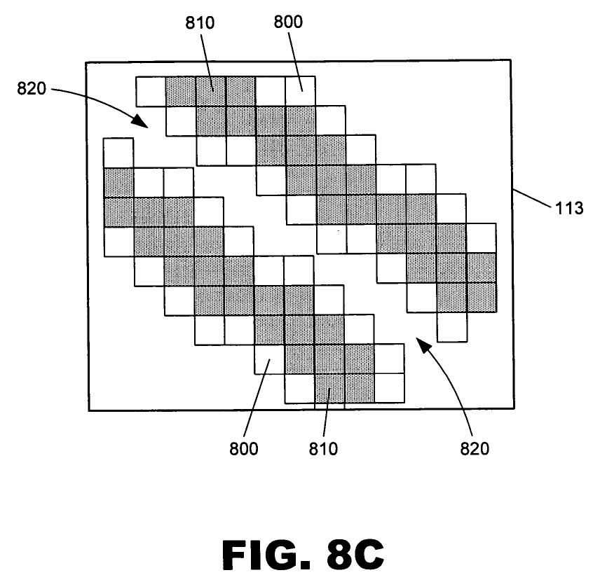

As shown in FIG. 7, the process begins by selectively depositing rapidly solidifying support material (step 700). FIG. 8A illustrates that according to the present alternative embodiment, the support material voxels (800) are selectively deposited with a high precision operating dispenser into a containment structure (805) configuration. The interior surface of the containment structure (113; FIG. 2) forms the surface that defines and contains the object build material (810). The support material voxels (800) may be linearly placed or deposited as a number of vertically stacked voxels to form a number of perimeter structures that may be connected to contain the build material (810). Additionally, the containment structure may be one or multiple voxels thick.

The configuration illustrated in FIG. 8A shows a number of containment structures (805) selectively placed with empty space between them. The empty space between the containment structures (805) define the voids (820) formed according to the present exemplary embodiment. Because the placement of the support material voxels (800) and subsequently the placement of the containment structures (805) is so critical to the definition of the defined voids (820) and the containment of the build material (810), the support material voxels are disposed with a material dispenser operating as a high precision material dispenser.

Once the containment structures (805) are formed, the build material (810) may be dispensed within the containment structures (step 710; FIG. 7). FIG. 8A illustrates a containment structure (113) according to one exemplary embodiment. The build material (810) may be dispensed by any number of material dispensers operating as a low precision dispenser including, but in no way limited to, an inkjet print head, a piezoelectric print head, a thermal inkjet print head, a continuous jet print head, a valve jet print head, or a syringe mechanism.

Once dispensed, the build material (810) may be permitted to naturally migrate and spread to fill the containment structure (805). If the build material remains a liquid until further solidified by additional processes, the support material (800) must be interconnected and rigid enough to support itself until the build material (810) is solidified.

The natural migration and spreading of the build material (810) within the containment structure (805) may be controlled by a number of factors including, but in no way limited to, the force of gravity on the build material (810), the viscosity of the build material, the surface tension of the build material, surface energy of the build material, and the wetting properties of the build material.

While traditional selective deposition SFF systems require a voxel of build material (810) to be dispensed at each location of the desired three-dimensional object, the present system and method allow a volume of build material (810) to be administered in bulk liquid form. The liquid build material may then be permitted to flow and subsequently fill the containment structure (805). As long as the build material (810) is applied to the interior of the containment structure (805), there may be multiple ejection locations, or as few as one single ejection location for the object build material according to principles described herein.

Once the containment structure (805) is filled with build material (810), the computing device (110; FIG. 1) coupled to the SFF apparatus (100; FIG. 1) determines whether the SFF build process is complete (step 720; FIG. 7). If multiple quantities of build material are to be formed, or if the selectively created pores are to have varying cross-sections, additional containment structures (805) may be formed. FIGS. 8B and 8C illustrate alternative configurations of containment structures that may be formed on top of one another to create a region of connected porosity having a varying cross-section. Employing multiple configurations also couples the various containment structures (805) together as a single three-dimensional object. The illustrated configurations are for demonstration purposes only and the present system and method are in no way limited to the exemplary structures shown.

Once the computing device determines that the build process has been completed (YES, step 720; FIG. 7), the build material may be further solidified (step 730; FIG. 7) and property enhancing material may be added to the selectively created pores (step 740; FIG. 7) as described previously without having to remove the support material (800).

While the method illustrated in FIG. 7 has been described as a sequential operation, it is within the scope of the present system and method to vary the steps described. For example, the SFF method may begin by simultaneously forming the containment structure (step 700) and dispensing the object build material (step 710). If the bulk build material (810; FIG. 8A) has a somewhat low viscosity and/or high surface tension, it may take some time to spread across and fill the containment structure (805; FIG. 8A). According to this exemplary embodiment, the containment structure (805; FIG. 8A) and the object build material (810; FIG. 8A) may be dispensed simultaneously, as long as the containment structure is sufficiently solidified by the time the object build material engages it.

In conclusion, the present SFF system and method effectively form selective pores in a three-dimensional object while retaining the speed, dimensional control, and other advantages of the polymer jefting technique. These pores may then be infiltrated with any number of property enhancing materials. Additionally, the present system and method present embodiments that reduce SFF costs by reducing the need for multiple high precision dispensers. More specifically, the present system and method permit the use of a material dispenser capable of operating as a high precision dispenser to selectively deposit the boundary area of a containment structure while using a low precision dispenser to deposit build material.

The preceding description has been presented only to illustrate and describe exemplary embodiments of the invention. It is not intended to be exhaustive or to limit the invention to any precise form disclosed. Many modifications and variations are possible in light of the above teaching. It is intended that the scope of the invention be defined by the following claims.

1. A method for producing porous structures in a three-dimensional object with solid freeform fabrication comprising:
selectively depositing a removable support material;
depositing a build material defining said three-dimensional object; and
removing said selectively deposited removable support material to form a number of pores within said three-dimensional object.

2. The method of claim 1, further comprising selectively depositing a non-removable support material

3. The method of claim 1, further comprising planarizing said build material or said removable support material.

4. The method of claim 1, further comprising solidifying said build material.

5. The method of claim 4, wherein said solidifying said build material comprises one of electromagnetic radiation, the application of heat, or a chemical cure activated by chemical agents present in said build material.

6. The method of claim 4, wherein said solidifying said build material occurs after said build material has flowed with respect to said removable support material.

7. The method of claim 1, further comprising infiltrating said pores with a property enhancing material.

8. The method of claim 7, wherein said property enhancing material comprises one of a high toughness material, a flexible material, a lubricant, an odorant, a de-odorant, a drug, a colorant, a reactive gas, a reactive liquid, an electrostatic or electromagnetic enhancing material, or an adhesive.

9. The method of claim 1, wherein said selectively depositing a removable support material comprises depositing said removable support material with a high-precision dispenser.

10. The method of claim 9, wherein said selectively depositing a removable support material further comprises vertically stacking a number of removable support material voxels.

11. The method of claim 9, wherein said selectively depositing a removable support material further comprises selectively depositing a number of removable support material voxels in a planar array configuration.

12. The method of claim 1, wherein said depositing a build material comprises depositing said build material with a low precision dispenser.

13. The method of claim 1, wherein said depositing a build material comprises depositing said build material with a high precision dispenser.

14. The method of claim 1, wherein said removing said selectively deposited removable support material comprises one of removal by manual separation, removal by dissolving said removable support material with a solvent, or removal by applying sufficient thermal energy to soften or melt said removable support material.

15. A method for producing porous structures in a three-dimensional object with solid freeform fabrication comprising:
selectively depositing a rapidly solidifying build material in a porous configuration; and
coupling said deposits of rapidly solidifying build material to form said three-dimensional object.

16. The method of claim 15, further comprising disposing a property enhancing material in said porous configuration.

17. The method of claim 16, wherein said property enhancing material comprises one of a high toughness material, a flexible material, a lubricant, an odorant, a de-odorant, a drug, a colorant, a reactive gas, a reactive liquid, an electrostatic or electromagnetic enhancing material, or an adhesive.

18. The method of claim 15, wherein said coupling said deposits of rapidly solidifying build material comprises depositing coupling material on said deposits of rapidly solidifying build material such that said coupling material overhangs said porous configuration.

19. The method of claim 15, wherein said selectively depositing a rapidly solidifying build material in a porous configuration comprises vertically stacking voxels of said rapidly solidifying build material with a high precision material dispenser.

20. The method of claim 15, wherein said selectively depositing rapidly solidifying build material in a porous configuration comprises depositing voxels of said rapidly solidifying build material in a planar array.

21. A method for producing porous structures in a three-dimensional object with solid freeform fabrication comprising:
forming a plurality of support material containment structures, wherein said containment structures are separated by a porous gap;
dispensing bulk build material into said support material containment structures; and
coupling said containment structures.

22. The method of claim 21, wherein said plurality of support material containment structures are formed with a high precision material dispenser.

23. The method of claim 22, wherein said forming a plurality of containment structures comprises stacking a plurality of support material voxels.

24. The method of claim 22, wherein said forming a plurality of containment structures comprises selectively disposing support material voxels in a planar array.

25. The method of claim 21, wherein said dispensing bulk build material comprises dispensing a specified quantity of build material with a low precision material dispenser.

26. The method of claim 21, wherein said coupling said containment structures comprises selectively dispensing build or support material that overhangs said porous gap.

27. The method of claim 21, further comprising infiltrating said porous gap with a property enhancing material.

28. The method of claim 27, wherein said property enhancing material comprises one of a high toughness material, a flexible material, a lubricant, an odorant, a de-odorant, a drug, a colorant, a reactive gas, a reactive liquid, an electrostatic or electromagnetic enhancing material, or an adhesive.

29. An object created by solid freeform fabrication, said object comprising:
a plurality of bound polymer jetted build material including a cured material; and
a plurality of cavities disposed within said object material, said cavities formed within said cured build material by selective deposition of a support material.

30. The object of claim 29, wherein said plurality of cavities are interconnected.

31. The object of claim 30, wherein said interconnected cavities extend to a surface of said object.

32. The object of claim 31, wherein said interconnected cavities are infiltrated by a property enhancing material.

33. The object of claim 32, wherein said interconnected cavities comprise variable cross-sections throughout said object.

34. The object of claim 32, wherein said property enhancing material comprises one of a high toughness material, a flexible material, a lubricant, an odorant, a de-odorant, a drug, a colorant, a reactive gas, a reactive liquid, an electrostatic or electromagnetic enhancing material, or an adhesive.

35. The object of claim 29, wherein said cavities were formed by the removal of said removable support material.

36. The object of claim 35, wherein said removable support material was removed by one of removal by manual separation, removal by dissolving said removable support material with a solvent, or removal by applying sufficient thermal energy to soften or melt said removable support material.

37. A solid freeform fabrication apparatus comprising:
a build platform;
a movable stage for distributing material on said build platform; and
a first material dispenser coupled to said movable stage;
wherein said first material dispenser functions as a high resolution dispenser to selectively deposit a porous forming removable support material.

38. The apparatus of claim 37, further comprising a roller configured to planarize said removable support material.

39. The apparatus of claim 37, further comprising a second material dispenser configured to dispense object build material around said removable support material.

40. The apparatus of claim 39, wherein said second material dispenser is configured to function as both a high precision material dispenser or as a low precision material dispenser.

41. The apparatus of claim 39, wherein said first material dispenser and said second material dispenser comprise inkjet print heads.

42. A solid freeform fabrication apparatus comprising:
a containment means for containing fabrication materials;
a distribution means for distributing said fabrication materials in said containment means;
a high resolution material dispensing means for selectively depositing a removable porous forming support material; and
a material dispensing means for dispensing a build material around said removable porous forming support material.

43. The solid freeform fabrication apparatus of claim 42, further comprising a planarizing means for planarizing said materials.

44. The solid freeform fabrication apparatus of claim 42, wherein said high resolution material dispensing means comprises an inkjet printhead.

45. A processor readable medium having instructions thereon for:
receiving data corresponding to a solid freeform fabrication object;
controlling a selective dispensing of material to form a removable support material, wherein said removable support material is dispensed with a high precision dispenser; and
controlling a dispensing of a build material around said removable support material to form said solid freeform fabrication object.

46. The processor readable medium of claim 45, wherein said high precision dispenser and said low precision dispenser comprise an inkjet print head.
